(19) United States
(12) Patent Application Publication
(10) Pub. No.: US 2020/0385879 A1
(43) Pub. Date: Dec. 10, 2020

(54) DISPERSED CATALYST-CONTAINING ANODE COMPOSITIONS FOR ELECTROLYZERS

(71) Applicant: 3M INNOVATIVE PROPERTIES COMPANY, St Pau, MN (US)

(72) Inventors: Andrew T. Haug, Woodbury, MN (US); John E. Abulu, Woodbury, MN (US); Krzysztof A. Lewinski, Mahtomedi, MN (US); Andrew J.L. Steinbach, Shoreview, MN (US); Fuxia Sun, Woodbury, MN (US)

(21) Appl. No.: 16/955,125

(22) PCT Filed: Dec. 19, 2018
(86) PCT No.: PCT/US2018/066345

§ 371 Date: Jun. 18, 2020

Related U.S. Application Data
(60) Provisional application No. 62/609,401, filed on Dec. 22, 2017.

(51) Int. Cl. C25B 11/04; C25B 9/10; C25B 11/02; C25B 1/10

(52) U.S. Cl. CPC C25B 11/0489; C25B 1/10; C25B 11/02; C25B 9/10

(57) ABSTRACT

Described herein is a plurality of acicular particles dispersed with ionomer binder for use in an electrolyzer. The acicular particles comprise a microstructured core with a layer of catalytic material on at least one portion of the surface of the microstructured core. The catalytic material comprises iridium and the microstructured core comprises at least one of a polynuclear aromatic hydrocarbon and heterocyclic compounds. The acicular particles are substantially free of platinum.

### TECHNICAL FIELD

Compositions comprising a dispersed catalyst for electrolyzer anodes are disclosed, including catalyst inks, anode electrodes, and catalyst coated substrates.

### SUMMARY

There is great interest in harnessing energy from renewable sources to achieve environmental cleanliness in the energy industry. The desire to be able to convert and store renewable energy has increased interest in hydrogen as a clean and environmentally benign energy carrier. Likewise, the growth of hydrogen-enabled mobility (e.g., motive fuel cells) adds further impetus to addressing needs for economical means to generate hydrogen.

Because renewable energy sources like wind and solar power are variable, polymer electrolyte membrane (PEM) water electrolysis has emerged as an attractive fuel generation source, both to convert excess solar and wind power to a storable hydrogen fuel and to generate further usable hydrogen fuel for various power needs.

Thus, there is a desire to identify less expensive and/or more efficient electrolyzers.

In one aspect, an electrode composition for an electrolyzer is described, the electrode composition comprising:

(a) an ionomer binder; and

(b) less than 54 solids volume % of a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum.

In another aspect, a catalyst ink composition is described the catalyst ink comprising:

(a) an ionomer binder;

(b) less than 54 solids volume % of a plurality of acicular particles, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and the acicular particles are substantially free of platinum; and

(c) solvent;

wherein the plurality of acicular particles is dispersed throughout the electrode composition.

In one embodiment, an article is provided. The article comprising:

a substrate with a coating thereon, the coating comprising (a) an ionomer binder; and (b) less than 54 solids volume % of a plurality of acicular particles, wherein the plurality of acicular particles is dispersed throughout the coating, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and the acicular particles are substantially free of platinum.

In one embodiment, an electrolyzer is provided. The electrolyzer comprising a proton-exchange membrane having first and second opposed major surfaces;
a cathode on the first major surface of the proton-exchange membrane;
an anode on the second major surface of the proton-exchange membrane;
a gas diffusion layer contacting the cathode;
an anode gas diffusion layer contacting the anode; and
   an electrical power source, wherein the anode comprises (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

The drawings illustrate generally, by way of example, but not by way of limitation, various embodiments discussed in the present document.

FIG. 1 illustrates an exemplary membrane electrode assembly described herein;

FIG. 2 illustrates cell voltage versus current density for various anodes;

FIG. 3 illustrates cell voltage versus current density for various anodes; and

FIG. 4 illustrates the current density at a cell voltage of 1.5 volts versus electrode loading for Examples 1-8 and Comparative Examples A-C.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the term

“and/or” is used to indicate one or both stated cases may occur, for example A and/or B includes, (A and B) and (A or B);

“highly fluorinated” refers to a compound wherein at least 75%, 80%, 85%, 90%, 95%, or even 99% of the C—H bonds are replaced by C—F bonds, and the remainder of the C—H bonds are selected from C—H bonds, C—Cl bonds, C—Br bonds, and combinations thereof;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and

“equivalent weight” (EW) of a polymer means the weight of polymer which will neutralize one equivalent of base;

“substituted” means, for a chemical species, substituted by conventional substituents which do not interfere with the desired product or process, e.g., substituents can be alkyl, alkoxy, aryl, phenyl, halo (F, Cl, Br, I), cyano, nitro, etc.;

“nanoscopic catalyst particle” means a particle of catalyst material having at least one dimension of about 10 nm or less or having a crystallite size of about 10 nm or less, measured as diffraction peak half widths in standard 2-theta x-ray diffraction scans; and

“discrete” refers to distinct elements, having a separate identity, but does not preclude elements from being in contact with one another.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed toward compositions that may be used in an anode of an electrolyzer. An electrolyzer is a device that can be used to produce hydrogen, carbon monoxide, or formic acid, etc. based on the input reactant (e.g., water or carbon dioxide).

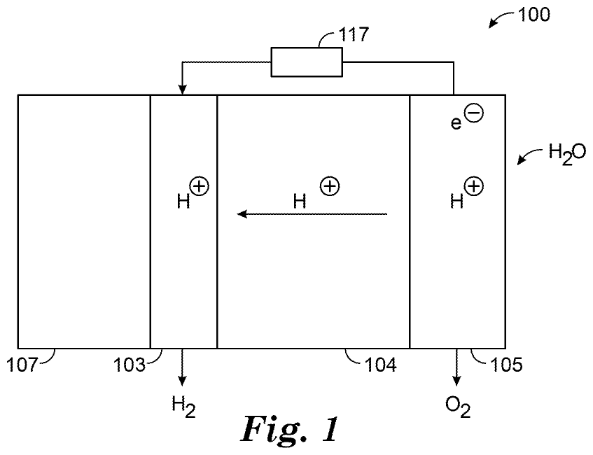

An exemplary electrolyzer is shown in FIG. 1, which includes membrane electrode assembly 100 having anode 105. Adjacent anode 105 is proton-exchange membrane 104 having first and second opposed major surfaces. Cathode 103 is situated adjacent proton-exchange membrane 104 on first major surface thereof, while anode 105 is adjacent second major surface of proton-exchange membrane 104. Gas diffusion layer 107 is situated adjacent cathode 103. Proton-exchange membrane 104 is electrically insulating and permits only hydrogen ions (e.g., protons) to pass through membrane 104.

In operation for the electrolysis of water, water is introduced into anode 105 of membrane electrode assembly 100. At anode 105, the water is separated into molecular oxygen (O₂), hydrogen ions (Fr), and electrons. The hydrogen ions diffuse through proton-exchange membrane 104 while electrical potential 117 drives electrons to cathode 103. At cathode 103, the hydrogen ions combine with electrons to form hydrogen gas.

The ion conducting membrane forms a durable, non-porous, electronically non-conductive mechanical barrier between the product gases, yet it also passes H⁺ ions readily. Gas diffusion layers (GDL's) facilitate reactant and product water transport to and from the anode and cathode electrode materials and conduct electrical current. In some embodiments, the anode and cathode electrode layers are applied to GDL's to form catalyst coated backing layers (CCB's) and the resulting CCB's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA. In operation, the five-layer MEA is positioned between two flow field plates to form an assembly and in some embodiments, more than one assembly is stacked together to form an electrolyzer stack.

The present disclosure is directed toward electrode catalyst-containing dispersion compositions and articles made therefrom. Such electrode catalyst-containing dispersion compositions comprise a plurality of acicular particles dispersed within an ionomer binder. The plurality of acicular particles are not oriented in the electrode composition. As used herein, “not oriented” refers to the acicular particles having a random orientation of their major axes with no observed pattern. These catalyst-containing dispersion compositions may be used in an electrolyzer's anode.

Acicular Particles

The acicular particles disclosed herein are discrete elongated particles comprising a plurality of microstructured cores, wherein at least one portion of the surface of the microstructured core comprises a layer of catalytic material.

The microstructured core is an elongated particle comprising an organic compound which acts as a support for a catalytic material disposed thereon. Although elongated, the microstructured cores of the present disclosure are not necessarily linear in shape and may be bent, curled or curved at the ends of the structures or the structure itself may be bent, curled or curved along its entire length.

The microstructured core is made from an organic compound. The organic compounds include planar molecules comprising chains or rings over which π-electron density is extensively delocalized. Organic compounds that are suitable for use in this disclosure generally crystallize in a herringbone configuration. Preferred compounds include those that can be broadly classified as polynuclear aromatic hydrocarbons and heterocyclic compounds. Polynuclear aromatic compounds are described in Morrison and Boyd, Organic Chemistry, Third Edition, Allyn and Bacon, Inc. (Boston: 1974), Chapter 30, and heterocyclic aromatic compounds are described in Morrison and Boyd, supra, Chapter 31. Among the classes of polynuclear aromatic hydrocarbons preferred for this disclosure are naphthalenes, phenanthrenes, perylenes, anthracenes, coronenes, pyrones, and derivatives of the compounds in the aforementioned classes. A preferred organic compound is commercially available perylene red pigment, N,N′-di(3,5-xylyl)perylene-3,4:9,10 bis(dicarboximide), hereinafter referred to as perylene red. Among the classes of heterocyclic aromatic compounds preferred for this disclosure are phthalocyanines, porphyrins, carbazoles, purines, pterins, and derivatives of the compounds in the aforementioned classes. Representative examples of plithalocyanines especially useful for this disclosure are phthalocyanine and its metal complexes, e.g., copper phthalocyanine A representative example of porphyrins useful for this disclosure is porphyrin.

Methods for making acicular elements are known in the art. For example, methods for making organic inicrostructural elements are disclosed in Materials Science and Engineering. A158 (1992), pp. 1-6; J. Vac. Sci. Technol. A, 5, (4), July/August, 1987, pp. 1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B.V., New York, (1985), pp. 1117-24; Photo. Sci. and Eng., 24, (4), July/August, 1980, pp. 211-16; and U.S. Pat. No. 4,568,598 (Bilkadi et al.) and U.S. Pat. No. 4,340,276 (Maffitt et al.), the disclosures of which patents are incorporated herein by reference. K. Robbie, et al, “Fabrication of Thin Films with Highly Porous Microstructures,” J. Vac. Sci. Tech. A, Vol. 13 No. 3, May/June 1995, pages 1032-35 and K. Robbie, et al., “First Thin Film Realization of Bianisotropic Medium,” J Vac. Sci. Tech. A, Vol. 13, No. 6, November/December 1995, pages 2991-93.

For example, the organic compound is coated onto a substrate using techniques known in the art including, for example, vacuum vapor deposition (e.g., vacuum evaporation, sublimation, and chemical vapor deposition), and solution coating or dispersion coating (e.g., dip coating, spray coating, spin coating, blade or knife coating, bar coating, roll coating, and pour coating (i.e., pouring a liquid onto a surface and allowing the liquid to flow over the surface)). The layer of organic compound is then treated (for example, annealing, plasma etching) such that the layer undergoes a physical change, wherein the layer of organic compound grows to form a microstructured layer comprising a dense array of discrete, oriented monocrystalline or polycrystalline microstructured cores. Following this method, the orientation of the major axis of the microstructured cores is usually normal to the substrate surface.

In one embodiment, the organic compound is vapor coated onto a substrate. The substrate can be varied, and is selected to be compatible with the heating process. Exemplary substrates include polyimide and metal foils. The temperature of the substrate during vapor deposition can be varied, depending upon the organic compound selected. For perylene red, a substrate temperature near room temperature (25° C.) is satisfactory. The rate of vacuum vapor deposition can be varied. Thickness of the layer of organic compound deposited can vary and the thickness chosen will determine the major dimension of the resultant microstructures after the annealing step is performed. Layer thicknesses is typically in a range from about 1 nm to about 1 micrometer, and preferably in a range from about 0.03 micrometer to about 0.5 micrometer. The layer of organic compound is then heated for a sufficient temperature and time, optionally under reduced pressure, such that the deposited organic compound undergoes a physical change resulting in the production of a microlayer comprising pure, single-or poly-crystalline microstructured cores. These single- or poly-crystalline microstructures are used to support a layer of catalytic material, forming the acicular particles of the present disclosure.

The catalytic material of the present disclosure comprises iridium. The iridium may be in a form of iridium metal, iridium oxide, and/or an iridium-containing compound such as IrOₓ, where x may be in the range from 0-2. In one embodiment, the catalytic material further comprises ruthenium, which may be in a form of ruthenium metal, ruthenium oxide, and/or may be a ruthenium-containing compound such as iridium oxide, RuOₓ, where x may be in the range from 0-2. In water-based electrolyzer applications, platinum-based anodes tend to be less efficient at oxygen evolution than their iridium counterparts. Thus, the acicular particles are substantially free of platinum (meaning that the composition comprises less than 1, 0.5, or even 0.1 atomic % of platinum in the catalytic material). The iridium and/or ruthenium includes alloys thereof, and intimate mixtures thereof.

The iridium and ruthenium may be disposed on the same microstructured core or may be disposed on separate microstructured cores.

The catalytic material is disposed on at least one surface (more preferably at least two or even three surfaces) of the plurality of microstructured cores. The catalytic material is disposed as a continuous layer across the surface such that electrons can continuously move from one portion of the acicular particle to another portion of the acicular particle. The layer of catalytic material on the surface of the organic compound creates a high number of reaction sites for oxygen evolution at the anode.

In one embodiment, the catalytic material is deposited onto the surface of the organic compound initially creating a nanostructured catalyst layer, wherein the layer comprises a nanoscopic catalyst particle or a thin catalyst film. In one embodiment, the nanoscopic catalyst particles are particles having at least one dimension equal to or smaller than about 10 nm or having a crystallite size of about 10 nm or less, as measured from diffraction peak half widths of standard 2-tetha x-ray diffraction scans. The catalytic material can be further deposited onto the surface of the organic compound to form a thin film comprising nanoscopic catalyst particles which may or may not be in contact with each other.

In one embodiment, the thickness of the layer of catalytic material on the surface of the organic compound can vary, but typically ranges from at least 0.3, 0.5, 1, or even 2 nm; and no more than 5, 10, 20, 40, 60, or even 100 nm on the sides of the microstructured cores.

In one embodiment, the catalytic material is applied to the microstructured cores by vacuum deposition, sputtering, physical vapor deposition, or chemical vapor deposition.

In one embodiment, the acicular particles of the present disclosure are formed by first growing the microstructured cores on a substrate as described above, applying a layer of catalytic material onto the microstructured cores, and then removing the catalytically-coated microstructured cores from the substrate to form loose acicular particles. Such methods of making microstructured cores and/or coating them with catalytic material are disclosed in, for example, U.S. Pat. No. 5,338,430 (Parsonage et al.); U.S. Pat. No. 5,879,827 (Debe et al.); U.S. Pat. No. 5,879,828 (Debe et al.); U.S. Pat. No. 6,040,077 (Debe et al.); and U.S. Pat. No. 6,319,293 (Debe et al.); U.S. Pat. No. 6,136,412 (Spiewak et al.); and U.S. Pat. No. 6,482,763 (Haugen et al.), herein incorporated by reference. Such methods of removing the catalytically-coated microstructured cores from the substrate are disclosed in, for example, U.S. Pat. Appl. No. 25001/0262828 (Noda et al) herein incorporated by reference.

Although the plurality of acicular particles can have a variety of shapes, the shape of the individual acicular particles is preferably uniform. Shapes include rods, cones, cylinders, and laths. In one embodiment, the acicular particles have a large aspect ratio, which is defined as the ratio of the length (major dimension) to the diameter or width (minor dimension). In one embodiment, the acicular particles have an average aspect ratio of at least 3, 5, 7, 10, or even 20 and at most 60, 70, 80, or even 100. In one embodiment, the acicular particles have an average length of more than 250, 300, 400, or even 500 nm (nanometer); and less than 750 nm, 1 micron, 1.5 microns, 2 microns, or even 5 microns. In one embodiment, the acicular particles have an average diameter (or width) of more than 15, 20, or even 30 nm; and less than 100 nm, 500 nm, 750 nm, 1 micron, 1.5 microns, or even 2 microns. Such length and diameter (or width) measurements can be obtained by transmission electron microscopy (TEM).

In one embodiment, the size, i.e. length and cross-sectional area, of the acicular particles are generally uniform from particle to particle. As used herein, the term “uniform”, with respect to size, means that the major dimension of the cross-section of the individual acicular particles varies no more than about 23% from the mean value of the major dimension and the minor dimension of the cross-section of the individual acicular particles varies no more than about 28% from the mean value of the minor dimension. The uniformity of the acicular particles provides uniformity in properties, and performance, of articles containing the acicular particles. Such properties include optical, electrical, and magnetic properties. For example, electromagnetic wave absorption, scattering, and trapping are highly dependent upon uniformity of the microlayer.

Ionomer Binder

The ionomer binder is a polymer electrolyte material, which may or may not be the same polymer electrolyte material of the membrane of the electrochemical cell. An ionomer binder is used to aid transport of ions through the electrode. The ionomer binder is a solid polymer, and as such, its presence in the electrode can inhibit transport of reactants to the electrocatalyst. In water electrolyzers, the reactant fluid is liquid water, not a gas. Reactant water transport through the PEM electrolyzer electrode is thought to be much faster than when using gas reactants. Therefore, because the present disclosure is directed toward electrolyzers, it is thought that more ionomer can be used in the electrode composition disclosed herein without reducing high current operation. Having a higher percentage of ionomer in the electrode may be advantageous from a cost perspective and/or enable optimum performance. In one embodiment, the electrode composition comprises less than 54, 52, 50, or even 48% by solids volume of the acicular particles versus the total solids volume of the electrode composition (i.e., comprising the acicular particles and the ionomer binder), and/or alternatively, greater than 46, 48, 50, or even 52% by solids volume of the ionomer versus the total solids volume of the electrode composition.

A useful polymer electrolyte material can include an anionic functional group such as a sulfonate group, a carbonate group, or a phosphonate group bonded to a polymer backbone and combinations and mixtures thereof In one embodiment, the anionic functional group is preferably a sulfonate group. The polymer electrolyte material can include an imide group, an amide group, or another acidic functional group, along with combinations and mixtures thereof

An example of a useful polymer electrolyte material is highly fluorinated, typically perfluorinated, fluorocarbon material. Such a fluorocarbon material can be a copolymer of tetrafluoroethylene and one or more types of fluorinated acidic functional co-monomers. Fluorocarbon resin has high chemical stability with respect to halogens, strong acids, and bases, so it can be beneficially used. For example, when high oxidation resistance or acid resistance is desirable, a fluorocarbon resin having a sulfonate group, a carbonate group, or a phosphonate group, and in particular a fluorocarbon resin having a sulfonate group can be beneficially used.

Exemplary fluorocarbon resins comprising a sulfonate group include perfluorosulfonic acid (e.g., Nafion), perfluorosulfonimide-acid (PFIA), sulfonated polyimides, sulfonated polytrifluorostyrene, sulfonated hydrocarbon polymer, polysulfone, and polyethersulfone. Other fluorocarbon resins include perfluoroimides such as perfluoromethyl imide (PFMI), and perfluorobutyl imide (PFBI). In one embodiment, the fluorocarbon resin is a polymer comprising multiple protogenic groups per sidechain.

Commercially available polymer electrolyte material includes those available, for example, under the trade designation “DYNEON” from 3M Company, St. Paul, Minn.; “NAFION” from DuPont Chemicals, Wilmington, Del.; “FLEMION” from Asahi Glass Co., Ltd., Tokyo, Japan; “ACIPLEX” from Asahi Kasei Chemicals, Tokyo, Japan; as well as those available from ElectroChem, Inc., Woburn, Mass. and Aldrich Chemical Co., Inc., Milwaukee, Wis.).

In one embodiment, the polymer electrolyte material is selected from a perfluoro-X-imide, where X may be, but is not limited to, methyl, butyl, propyl, phenyl, etc.

Typically, the equivalent weight of the ion conductive polymer is at least about 400, 500, 600 or even 700; and not greater than about 825, 900, 1000, 1100, 1200, or even 1500.

In one embodiment, the ratio of ionomer binder to the acicular particle is 1:100 to 1:1 by weight, more preferably 1:20 to 1:2 by weight.

In one embodiment, the ratio of ionomer binder to the acicular particle is 1:10 to 10:1 by volume, more preferably 1:3 to 3:1 by volume. Solvent

Typically, the plurality of microstructed elements is applied along with the ionomer binder, and various solvents in the form of a dispersion, for example, an ink or a paste.

In one embodiment, the plurality of acicular particles and ionomer binder are dispersed in a solvent. Exemplary solvents include water, ketones (such as acetone, tetrahydrofuran, methyl ethyl ketone, and cyclohexanone), alcohols (such as methanol, isopropanol, propanol, ethanol, and propylene glycol butyl ether), polyalcohols (such as glycerin and ethylene glycol); hydrocarbons (such as cyclohexane, heptane, and octane), dimethyl sulfoxide, and fluorinated solvents such as heptadecafluorooctane sulfonic acid and partially fluorinated or perfluorinated alkanes or tertiary amines (such as those available under the trade designations “3M NOVEC ENGINEERED FLUID” or “3M FLUOROINERT ELECTRONIC LIQUID”, available from 3M Co., St. Paul, Minn.

In one embodiment, the catalyst ink composition is an aqueous dispersion, optionally comprising water and one or more solvents and optionally a surfactant.

In one embodiment, the catalyst ink composition contains 0.1-50%, 5-40%, 10-25%, and more preferably 1-10% by weight of the solvent per weight of the solids (i.e., plurality of acicular particles, and ionomer binder,).

Articles

In one embodiment, the catalyst composition is applied onto a substrate such as a polymer electrolyte membrane (PEM) or a gas diffusion layer (GDL); or a transfer substrate and subsequently transferred onto a PEM or GDL.

PEMs are known in the art. PEMs may comprise any suitable polymer electrolyte. The polymer electrolytes typically bear anionic functional groups bound to a common backbone, which are typically sulfonic acid groups, but may also include carboxylic acid groups, imide groups, amide groups, or other acidic functional groups. The polymer electrolytes are typically highly fluorinated and most typically perfluorinated. Exemplary polymer electrolytes include those mentioned for the ionomer binder above. The polymer electrolytes are typically cast as a film (i.e. membrane) having a thickness of less than 250 microns, more typically less than 175 microns, more typically less than 125 microns, in some embodiments less than 100 microns, and in some embodiments about 50 microns. The PEM may consist of the polymer electrolyte or the polymer electrolyte may be imbibed into a porous support (such as PTFE). Examples of known PEMs include those available under the trade designations: “NAFION PFSA MEMBRANES” by E.I. du Pont de Nemours and Co., Wilmington, Del.; “GORESELECT MEMBRANE” by W.L. Gore&Associates, Inc., Newark, Del.; and “ACIPLEX” by Asahi Kasei Corp., Tokyo, Japan; and 3M membranes from 3M Co., St. Paul, Minn.

GDLs are also known in the art. In one embodiment, the anode GDL is a sintered metal fiber nonwoven or felt such as those disclosed in CN 203574057 (Meekers, et al.), and WO 2016/075005 (Van Haver, et al.) coated or impregnated with a metal comprising at least one of titanium, platinum, gold, iridium, or combinations thereof.

Transfer substrates are a temporary support that is not intended for final use of the electrode and is used during the manufacture or storage to support and/or protect the electrode. The transfer substrate is removed from the electrode article prior to use. The transfer substrate comprises a backing often coated with a release coating. The electrode is disposed on the release coating, which allows for easy, clean removal of the electrode from the transfer substrate. Such transfer substrates are known in the art. The backing often is comprised of PTFE, polyimide, polyethylene terephthalate, polyethylene naphthalate (PEN), polyester, and similar materials with or without a release agent coating.

Examples of release agents include carbamates, urethanes, silicones, fluorocarbons, fluorosilicones, and combinations thereof. Carbamate release agents generally have long side chains arid relatively high softening points. An exemplary carbamate release agent is polyvinyl octadecyl carbarnate, available from Anderson Development Co. of Adrian, Mich., under the trade designation “ESCOAT P20”, and from Mayzo Inc. of Norcross, Ga., marketed in various grades as RA-95H, RA-95HS, RA-155 and RA-585S.

Illustrative examples of surface applied (i.e., topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat, Nos. 4,313,988 (Bany et al.) and 4,482,687 (Kessel et al.), polyorganosiloxane-polyurea block copolymers such as are disclosed in U.S. Pat. No. 5,512,650 (Leir et al.), etc.

Silicone release agents generally comprise an organopolysiloxane polymer comprising at least two crosslinkable reactive groups, e.g., two ethylenically-unsaturated organic groups. In some embodiments, the silicone polymer comprises two terminal crosslinkable groups, e.g., two terminal ethylenically-unsaturated groups. In some embodiments, the silicone polymer comprises pendant functional groups, e.g., pendant ethylenically-unsaturated organic groups. In some embodiments, the silicone polymer has a vinyl equivalent weight of no greater than 20,000 grams per equivalent, e.g., no greater than 15,000, or even no greater than 10,000 grams per equivalent. In some embodiments, the silicone polymer has a vinyl equivalent weight of at least 250 grams per equivalent, e.g., at least 500, or even at least 1000 grams per equivalent. In some embodiments, the silicone polymer has a vinyl equivalent weight of 500 to 5000 grams per equivalent, e.g., 750 to 4000 grams per equivalent, or even 1000 to 3000 grams per equivalent.

Commercially available silicone polymers include those available under the trade designations “DMS-V” from Gelest Inc., e.g., DMS-V05, DMS-V21, DMS-V22, DMS-V25, DMS-V31, and DMS-V33. Other commercially available silicone polymers comprising an average of at least two ethylenically-unsaturated organic groups include “SYL-OFF 2-7170” and “SYL-OFF 7850” (available from Dow Corning Corporation), “VMS-T11” and “SIT7900” (available from Gelest Inc.), “SILMER VIN 70”, “SILMER VIN 100” and “SILMER VIN 200” (available from Siltech Corporation), and 2,4,6,8-tetramethyl-2,4,6,8-tetravinylcyclotetrasiloxane (available from Aldrich).

The release agent may also comprise a fluorosilicone polymer. Commercially available ethylenically unsaturated fluorosilicone polymers are available from Dow Corning Corp. (Midland, Mich.) under the SYL-OFF series of trade designations including, e.g., “SYL-OFF FOPS-7785” and “SYL-OFF FOPS-7786”. Other ethylenically unsaturated fluorosilicone polymers are commercially available from General Electric Co. (Albany, NY), and Wacker Chemie (Germany). Additional useful ethylenically unsaturated fluorosilicone polymers are described as component (e) at column 5, line 67 through column 7, line 27 of U.S. Pat. No. 5,082,706 (Tangney). Fluorosilicone polymers are particularly useful in forming release coating compositions when combined with a suitable crosslinking agent. One useful crosslinking agent is available under the trade designation “SYL-OFF Q2-7560” from Dow Corning Corp. Other useful crosslinking agents are disclosed in U.S. Pat. Nos. 5,082,706 (Tangney) and 5,578,381 (Hamada et al.).

The electrode composition may be initially mixed together in an ink, paste or dispersion. As such, the electrode composition may then be applied to a PEM, GDL, or transfer article in one or multiple layers, with each layer having the same composition or with some layers having differing compositions. Coating techniques as known in the art may be used to coat the electrode composition onto a substrate. Exemplary coating methods include knife coating, bar coating, gravure coating, spray coating, etc.

After coating, the coated substrate is typically dried to at least partially remove the solvent from the electrode composition, leaving an electrode layer on the substrate.

In one embodiment, the composition comprises less than 54, 52, 50, or even 48% by solids volume of the acicular particles versus the total solids volume of the composition (i.e., comprising the acicular particles and the ionomer binder). If there are not enough acicular particles present in the resulting electrode, there will be insufficient electrical conductivity and performance may be reduced. Therefore, in one embodiment, the composition comprises at least 1, 5, 10, 20 or even 25% by solids volume of the acicular particles versus the total solids volume of the composition to conduct.

If the coating is applied to the transfer substrate, the electrode is typically transferred to the surface of the PEM. In one embodiment, the coated transfer substrate is pressed against the PEM with heat and pressure, after which the coated transfer substrate is removed and discarded, leaving the electrode bonded to the surface of the PEM.

In one embodiment, the coating is incorporated into an electrolyzer, such as a water electrolyzer as discussed in FIG. 1.

In addition to the membrane electrode assembly including the cathode gas diffusion layer, cathode, proton-exchange membrane, anode, and anode gas diffusion layer, the electrolyzer can further include a cathode gasket in contact with the cathode gas diffusion layer.

The membrane electrode assembly is typically installed between a set of flow field plates, which enables the distribution of reactant water to the anode electrode, the removal of product oxygen from the anode and product hydrogen from the cathode, and the application of an electrical voltage and current to the electrodes. The flow field plates are typically non-porous plates comprising flow channels, have low permeability towards the reactants and products, and are electrically conductive.

The flow field and MEA assembly can be repeated, yielding a stack of repeating units which are typically connected electrically in series.

The cell assembly may also comprise a set of current collectors and compression hardware.

In the case of a water input, operation of the electrolyzer produces hydrogen and oxygen gases, and consumes water and electrical energy. Application of a voltage across the cell of 1.23V or higher is required to electrochemically produce hydrogen and oxygen from water at standard conditions. As the cell voltage is increased to 1.23V and above, an electronic current commences between the anode and cathode. The electronic current is proportional to the rate of water consumption and the production of hydrogen and oxygen.

The electrolyzer of the present disclosure can have any suitable operational current density consistent with the membrane electrode assembly described herein, for example, an operational current density at 80° C. in a range from 0.001 A/cm² to 30 A/cm², 0.5 A/cm² to 25 A/cm², 1 A/cm² to 20 A/cm², 2 A/cm² to 10 A/cm², or less than, equal to, or greater than 0.001 A/cm², 0.01, 0.1, 0.5, 1, 2, 3, 4, 5, 6, 7, 8, 9, 10, 11, 12, 13, 14, 15, 16, 17, 18, 19, 20, 22, 24, 26, 28 A/cm², or 30 A/cm² or more.

In general, the measured current density is an approximate proportional measure of the absolute catalytic activity of the anode electrode. The relationship between current density and catalytic activity is especially true at low electrode overpotentials. With all other components and operating conditions fixed, higher current densities at a given cell voltage indicated higher absolute catalyst activity. It is generally thought that increasing the catalyst surface area per unit planar area is expected to proportionately increase the absolute catalyst activity, due to increasing the number of active catalytic sites per unit planar area. Methods for increasing the catalyst surface area per unit electrode planar area include (1) increasing the catalyst (i.e., Ir) content of the electrode (i.e., higher Ir areal loadings per unit electrode planar area) and (2) increasing the catalyst (i.e., Ir) surface area per unit Ir content (i.e., higher specific surface area, m² of Ir electrochemical surface per grams of Ir). Without being bound by theory, the specific surface area (m²/g) would be expected to increase as the Ir metal thin film thickness on the whisker decreases, due to an increasing fraction of the Ir metal being at the thin film surface, rather than within the bulk of the film. Based on the PR 149 whisker geometry, substantially larger absolute incremental area gains would be expected to occur as the Ir thin film thickness on the PR 149 whisker support decreases below about 10 nm.

Traditionally, it is expected that there may be a limitation of a minimum practical catalyst coating thickness on the whisker support, below which the catalyst may be substantially deactivated. Operation of an anode electrode for an electrolyzer requires electronic conduction within the electrode, to enable the electrochemical oxygen evolution reaction. In electrodes comprising catalyst-coated acicular particles and ionomer and which do not comprise any other electronic conductor, electronic conduction within the electrode is believed to occur only within the metallic catalyst. As the thickness decreases, the catalyst thin film may not be thermodynamically stable and may instead take the form of individual grains which are not in contact with each other. If the catalyst is in the form of individual grains which are not in contact with each other, some fraction of catalyst material will not be electrochemically active due to lack of electronic conduction, and performance will be lost.

In the present disclosure, it unexpectedly has been found that the use of dispersed acicular particles in the anode of an electrolyzer causes the current density at a particular voltage to increase monotonically as the catalytic material thickness on the microstructured core decreases. This enables less catalytic material to be used.

In various embodiments, the present disclosure provides a method of using the electrolyzer. The method can be any suitable method of using any embodiment of the electrolyzer described herein. For example, the method can include applying an electrical potential across the anode and the cathode. In one embodiment, the anode may be used for an oxygen evolution reaction such as in water electrolysis or carbon dioxide electrolysis. In one embodiment, in water electrolysis with an acidic membrane electrode assembly, water (e.g., any suitable water, such as deionized water) can be provided to the anode and oxygen gas can be generated at the anode side and hydrogen gas at the cathode side. In one embodiment, in water electrolysis with an alkaline membrane electrode assembly, water can be provided to the cathode side and oxygen gas can be generated at the anode side and hydrogen gas at the cathode side. In one embodiment, in carbon dioxide electrolysis, carbon dioxide can be provided to the cathode side, producing oxygen at the anode side and carbon monoxide at the cathode side.

Exemplary embodiments of the present disclosure include, but are not limited to, the following.

Embodiment 1. An electrode composition for an electrolyzer, the electrode composition comprising:

(a) an ionomer binder; and
(b) less than 54 solids volume % of a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum.

Embodiment 2. The electrode composition of embodiment 1, wherein the catalytic material further comprises at least one of ruthenium or ruthenium oxide.

Embodiment 3. The electrode composition of any one of the previous embodiments, wherein the iridium comprises iridium oxide.

Embodiment 4. The composition of any one of the previous embodiments, wherein the layer of catalytic material comprises a nanostructured catalyst layer.

Embodiment 5. The composition of any one of the previous embodiments, wherein the polynuclear aromatic hydrocarbon comprises perylene red.

Embodiment 6. The composition of any one of the previous embodiments, wherein the acicular particles have an aspect ratio of at least 3.

Embodiment 7. The composition of any one of the previous embodiments, wherein the ionomer binder comprises at least one of perfluorosulfornic acid, perfluorosulfonimide-acid, sulfonated polyimides, perfluoroimides, sulfonated polytrifluorostyrene, sulfonated hydrocarbon polymer, polysulfone, polyethersulfone, and combinations thereof.

Embodiment 8. The composition of any one of the previous embodiments, wherein the ionomer binder has an equivalent weight of not greater than 1100.

Embodiment 9. The electrode composition of any one of the previous embodiments, wherein the layer of catalytic material on the at least one portion of the surface of the microstructured core has a thickness of less than 100 nm.

Embodiment 10. The electrode composition of any one of the previous embodiments, wherein the layer of catalytic material on the at least one portion of the surface of the microstructured core has a thickness of at least 0.5 nm and at most 10 nm.

Embodiment 11. The composition of any one of the previous embodiments, wherein the solvent comprises at least one of an alcohol, a polyalcohol, a ketone, water, a fluorinated solvent, and combinations thereof.

Embodiment 12. A catalyst ink composition for an electrolyzer, the composition comprising:

(a) an ionomer binder;
(b) less than 54 solids volume % of a plurality of acicular particles, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof; wherein the catalytic material comprises iridium; and wherein the acicular particles are substantially free of platinum; and
(c) solvent;
wherein the plurality of acicular particles is dispersed throughout the electrode composition.

Embodiment 13. The catalyst ink of embodiment 12, wherein the composition comprises 1-40 wt % solids.

Embodiment 14. An article comprising:

a substrate with a coating thereon, the coating comprising (a) an ionomer binder; and (b) less than 54 solids volume % of a plurality of acicular particles, wherein the plurality of acicular particles is dispersed throughout the coating, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof; wherein the catalytic material comprises iridium; and wherein the acicular particles are substantially free of platinum.

Embodiment 15. The article of embodiment 14, wherein the substrate is a gas diffusion layer, a liner, or an ion conductive membrane.

Embodiment 16. Use of a composition an anode for an oxygen evolution reaction, the composition comprising (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum.

Embodiment 17. Use according to embodiment 16, wherein the oxygen evolution reaction occurs in a water electrolyzer or a carbon dioxide electrolyzer.

Embodiment 18. Use according to any one of embodiments 16-17, wherein the composition comprises less than 54 solids volume % of the plurality of acicular particles.

Embodiment 19. Use according to any one of embodiments 16-18, wherein the layer of catalytic material comprises a nanostructured catalyst layer.

Embodiment 20. Use according to any one of embodiments 16-19, wherein the polynuclear aromatic hydrocarbon comprises perylene red.

Embodiment 21. Use according to any one of embodiments 16-20, wherein the acicular particles have an aspect ratio of at least 3.

Embodiment 22. Use according to any one of embodiments 16-21, wherein the layer of catalytic material on the at least one portion of the surface of the microstructured core has a thickness of less than 100 nm.

Embodiment 23. Use according to any one of embodiments 16-22, wherein the layer of catalytic material on the at least one portion of the surface of the microstructured core has a thickness of at least 0.5 nm and at most 10 nm.

Embodiment 24. An electrolyzer comprising:

a proton-exchange membrane having first and second opposed major surfaces;
a cathode on the first major surface of the proton-exchange membrane;
an anode on the second major surface of the proton-exchange membrane, wherein the anode comprises (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum;
a first gas diffusion layer contacting the cathode;
a second gas diffusion layer contacting the anode; and
an electrical power source connected to the cathode and the anode.

Embodiment 25. The electrolyzer of embodiment 24, wherein the composition comprises less than 54 solids volume % of the plurality of acicular particles.

Embodiment 26. The electrolyzer according to any one of embodiments 24-25, wherein the layer of catalytic material comprises a nanostructured catalyst layer.

Embodiment 27. The electrolyzer according to any one of embodiments 24-26, wherein the polynuclear aromatic hydrocarbon comprises perylene red.

Embodiment 28. The electrolyzer according to any one of embodiments 24-27, wherein the acicular particles have an aspect ratio of at least 3.

Embodiment 29. The electrolyzer according to any one of embodiments 24-28, wherein the layer of catalytic material on the at least one portion of the surface of the microstructured core has a thickness of less than 100 nm.

Embodiment 30. The electrolyzer according to any one of embodiments 24-29, wherein the layer of catalytic material on the at least one portion of the surface of the microstructured core has a thickness of at least 0.5 nm and at most 10 nm.

Embodiment 31. A method of generating hydrogen and oxygen from water comprising:
obtaining an electrolyzer comprising an anode portion and a cathode portion and an ion conductive membrane there between, wherein the anode comprises an electrode composition, wherein the electrode composition comprises (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum;
adding water into the anode portion of the electrolyzer; and
applying an electrical potential difference between the anode portion and the cathode portion sufficient to generate hydrogen and oxygen from water.

Embodiment 32. A method of generating carbon monoxide and oxygen from carbon dioxide comprising:
obtaining an electrolyzer comprising an anode portion and a cathode portion and an ion conductive membrane there between, wherein the anode comprises the electrode composition wherein the electrode composition comprises (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum;
adding carbon dioxide into the cathode portion of the electrolyzer; and applying an electrical potential difference between the anode portion and the cathode portion sufficient to generate carbon monoxide and oxygen from carbon dioxide.

Embodiment 33. The method according to any one of embodiments 31-32, wherein the composition comprises less than 54 solids volume % of the plurality of acicular particles.

Embodiment 34. The method according to any one of embodiments 31-33, wherein the layer of catalytic material comprises a nanostructured catalyst layer.

Embodiment 35. The method according to any one of embodiments 31-34, wherein the polynuclear aromatic hydrocarbon comprises perylene red.

Embodiment 36. The method according to any one of embodiments 31-35, wherein the acicular particles have an aspect ratio of at least 3.

Embodiment 37. The method according to any one of embodiments 31-36, wherein the layer of catalytic material on the at least one portion of the surface of the microstructured core has a thickness of less than 100 nm.

Embodiment 38. The method according to any one of embodiments 31-37, wherein the layer of catalytic material on the at least one portion of the surface of the microstructured core has a thickness of at least 0.5 nm and at most 10 nm.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

These abbreviations are used in the following examples: A=amps, cm=centimeters, g=grams, ° C.=degrees Celsius, RH=relative humidity, mA=milliamps, mol=moles, sccm=standard cubic centimeters per minute, and V=volt.

Materials for preparing the Comparative Examples and Examples include those in Table 1, below.

TABLE 1

| Abbreviation or | |
|---|---|
| Trade Designation | Source |
| “PR 149” | Perylene red pigment (i.e., N,N′-di(3,5- |
| | xylyl)perylene-3,4:9,10-bis(dicarboximide)), |
| | obtained under the trade designation “C.I. |
| | PIGMENT RED 149,” also known as “PR |
| | 149,” from Clariant, Charlotte, NC. |
| “3M825EW | 825 g/mol equivalent weight polymeric |
| MEMBRANE” | perfluorosulfonic acid proton exchange |
| | membrane (PEM), obtained under the trade |
| | designation “3M825EW MEMBRANE” from |
| | 3M Company, St. Paul, MN. |
| “3M725EW | 725 g/mol equivalent weight polymeric |
| POWDER” | perfluorosulfonic acid ion exchange resin, |
| | obtained under the trade designation |
| | “3M725EW POWDER” from 3M Company. |
| “Ir-NSTF” | Iridium/iridium oxide nanostructured thin film |
| | (NSTF) catalyst supported on “PR 149” |
| | whiskers. |
| “KAPTON” | Polyimide film, obtained under the trade |
| | designation “KAPTON” from DuPont, |
| | Wilmington, DE. |
| “MCTS” | Microstructured catalyst transfer substrate, |
| | obtained from 3M Company, St. Paul, MN. |

Preparation of Electrodes

Preparing web of supported microstructured whiskers

Microstructured whiskers were prepared by thermally annealing a layer of perylene red pigment (PR 149) that was sublimation vacuum coated onto microstructured catalyst transfer polymer substrates (MCTS) with a nominal thickness of 220 nm, as described in detail in U.S. Pat. No. 4,812,352 (Debe), the disclosure of which is incorporated herein by reference.

A roll-good web of the MCTS (made on a polyimide film (“KAPTON”)) was used as the substrate on which the PR149 was deposited, as described in detail in U.S. Pat. No. 6,136,412 (Spiewak et al.,) the disclosure of which is incorporated herein by reference. The MCTS substrate surface had V-shaped features with about 3 micrometer tall peaks, spaced 6 micrometers apart. A nominally 100 nm thick layer of Cr was then sputter deposited onto the

MCTS surface using a DC magnetron planar sputtering target and typical background pressures of Ar and target powers known to those skilled in the art sufficient to deposit the Cr in a single pass of the MCTS web under the target at the desired web speed.

The Cr-coated MCTS web then continued over a sublimation source containing the perylene red pigment (PR 149). The perylene red pigment (PR 149) was heated to a controlled temperature near 500° C. to generate sufficient vapor pressure flux to deposit 0.022 mg/cm², or an approximately 220 nm thick layer of the perylene red pigment (PR 149) in a single pass of the web over the sublimation source. The mass or thickness deposition rate of the sublimation can be measured in any suitable fashion known to those skilled in the art, including optical methods sensitive to film thickness, or quartz crystal oscillator devices sensitive to mass. The perylene red pigment (PR 149) coating was then converted to the whisker phase by thermal annealing, as described in detail in U.S. Pat. No. 5,039,561 (Debe) the disclosure of which is incorporated herein by reference, by passing the perylene red pigment (PR 149) coated web through a vacuum having a temperature distribution sufficient to convert the perylene red pigment (PR 149) as-deposited layer into a layer of oriented crystalline whiskers at the desired web speed, such that the whisker layer has an average whisker areal number density of about 68 whiskers per square micrometer, determined from scanning electron microscopy (SEM) images, with an average length of about 0.6 micrometer.

Preparing catalyst coated nanostructured thin films on supported microstructured whiskers.

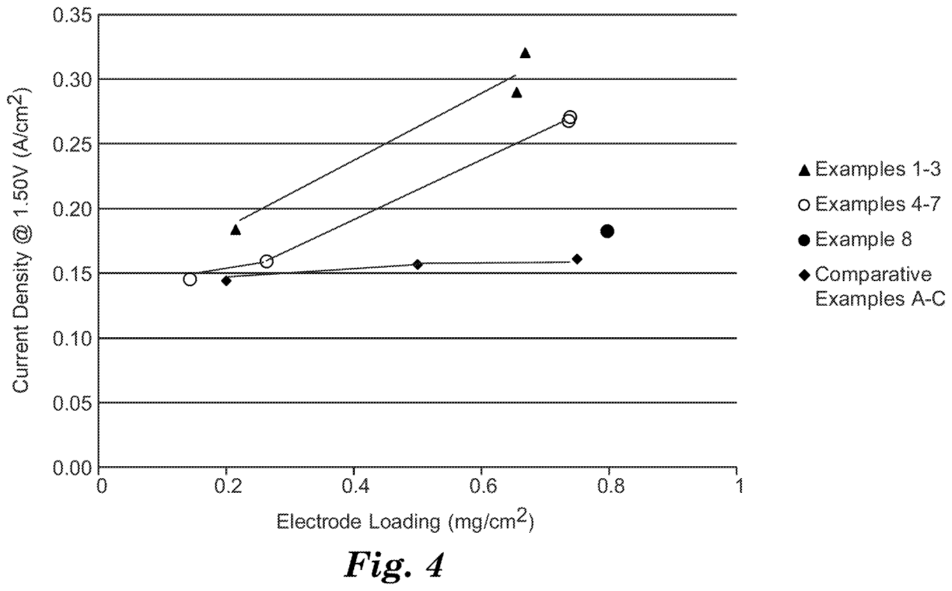

A catalyst coated nanostructured thin film (NSTF) was prepared by sputter coating the catalyst onto the web of supported microstructured whiskers from above using a vacuum sputter deposition system similar to that described in FIG. 4A of U.S. Pat. No. 5,338,430 (Parsonage et al.,) but equipped with additional capability to allow coatings on roll-good substrate webs. The coatings were sputter deposited by using ultra high purity Ar as the sputtering gas at approximately 5 mTorr pressure. Catalyst layers were deposited onto the web of supported nanostructured whiskers by exposing the roll-good substrate in sections to an energized 5 inch×15 inch (13 cm×38 cm) planar sputtering target, resulting in the deposition of the catalyst onto the surface of the entire roll-good substrate. The magnetron sputtering target deposition rate and web speed were controlled to give the desired areal loading of catalyst on the substrate. The DC magnetron sputtering target deposition rate and web speed were measured by standard methods known to those skilled in the art. The substrate was repeatedly exposed to the energized sputtering target, resulting in additional deposition of catalyst onto the substrate, until the desired areal loading was obtained.

Cathode Preparation

For the cathode preparation, the sputtering target was a pure 5 inch×15 inch (13 cm×38 cm) planar Pt sputter target (obtained from Materion, Clifton, N.J.) resulting in the deposition of Pt onto the web of supported nanostructured whiskers to form Pt-NSTF having 0.25 mg/cm² platinum nanostructured thin film catalyst supported on “PR 149” whiskers.

Anode Preparatory Examples A-C

For Preparatory Examples A-C, the sputtering target was a 5 inch×15 inch (13 cm×38 cm) planar Ir sputtering target (obtained from Materion, Clifton, N.J.,) resulting in the deposition of Ir onto the web of supported nanostructured whiskers. Table 2 summarizes the characteristics of Preparatory Examples A-C.

For example, for Preparatory Example A, the Ir areal loading on substrate was 0.75 mg/cm² and the PR 149 areal loading on the substrate was 0.022 mg/cm², yielding an acicular catalyst particle that was 97.2 wt (weight) % Ir. The planar equivalent thickness of 0.75 mg/cm² was calculated to be 332 nm, based on the density of Ir metal, 22.56 g/cm³. Preparatory Example A was deposited onto the PR 149 whisker support on MCTS described above, which was estimated to have approximately 10 cm² of surface area per cm² planar area, i.e., a roughness factor of about 10. A 332-nm planar equivalent coating onto a substrate with a roughness factor of 10 will have a thickness of approximately 33.2 nm on the PR 149 whisker support, i.e., 1/10^{th} the planar equivalent thickness. The physical thickness of the Ir coating of Comparative Example A could be assessed directly by Transmission Electron Microscopy (TEM.) Without being bound by theory, the morphology of a 33.2 nm Ir coating the PR 149 support is expected to be in the form of a Ir metal thin film, consisting of fused Ir metal grains.

Anode Preparatory Example D-F

For Preparatory Examples D-F, the sputtering target was a 5 inch×15 inch (13 cm×38 cm) planar Ir sputtering target (obtained from Materion, Clifton, N.J.,) resulting in the deposition of Ir onto the web of supported nanostructured whiskers. Shown in Table 2 is the Ir areal loading on the growth substrate and the PR 149 areal loading on the growth substrate.

TABLE 2

| | | PR 149 | | | Estimated |
|---|---|---|---|---|---|
| | Ir Areal | Areal | | Ir Planar | Ir |
| | Loading | Loading | Ir | Equivalent | Thickness |
| | on | on | Weight | Thickness | on |
| | Growth | Growth | % of | on Growth | PR 149 |
| | Substrate | Substrate | Catalyst | Substrate | Whisker |
| Example | (mg/cm²) | (mg/cm²) | Particle | (nm) | (nm) |
| Preparatory | 0.750 | 0.022 | 97.2 | 332 | 33.2 |
| Example A | | | | | |
| Preparatory | 0.500 | 0.022 | 95.8 | 222 | 22.2 |
| Example B | | | | | |
| Preparatory | 0.200 | 0.022 | 90.1 | 89 | 8.9 |
| Example C | | | | | |
| Preparatory | 0.050 | 0.022 | 69.4 | 22 | 2.2 |
| Example D | | | | | |
| Preparatory | 0.100 | 0.022 | 82.0 | 44 | 4.4 |
| Example E | | | | | |
| Preparatory | 0.375 | 0.022 | 94.5 | 166 | 16.6 |
| Example F | | | | | |

Example A: The Ir-coated PR 149 whiskers from Preparatory Example D were removed from the MCTS substrate via a manual brushing method, described as follows. Roughly 30 inches of the catalyst on MCTS substrate was unrolled in a hood, catalyst coating side showing face-up. An 1895 Stencil #6 brush (China Stencil) was held, bristles-down, against the film. Using a smooth, dragging motion, the brush was moved across the film, removing whiskers. This brush motion was continued until practically all whiskers were removed from the film, leaving a shiny chrome surface. The removed whiskers, now at one end of the film, were brushed into a 70-mm aluminum dish (VWR). The whiskers were then poured from this dish into a glass bottle for weighing and storage. A new 30 inch (76 cm)-length of NSTF+Ir whisker-coated film was then unrolled and the brushing process was repeated until sufficient quantities of whiskers (1 to 5 grams) were obtained.

2.0 grams of brushed catalyst were then placed into a 125-mL polyethylene bottle (VWR). This bottle was then moved to a nitrogen-only-containing glove bag (VWR) for safely adding additional solvents. After at least 5 minutes in the nitrogen bag, 0.5 grams of water, 12 grams of t-butanol, and 1.5 grams of propylene glycol butyl ether were added to the bottle. This was then briefly shaken before 1.26 grams of 3M725EW ionomer solution (18.8 wt % solids in a solvent 60:40 nPa:water by weight) (725EW ionomer powder is available from 3M company, St. Paul, Minn., USA) was added to the mixture. Finally, 50 grams of 6 mm ZrO2 media (high density zirconium oxide balls, 5 mm diameter, 6 g/cm³ density, available from Glen Mills Clifton, N.J.) was added to the bottle. This was first shaken for up to 1 minute and then rolled on an automated roller (i.e., ball milled) at between 60 and 180 RPM for 24 hours and the electrode ink is separated from the ZrO2 media. Electrodes made from this electrode ink, once dried, are calculated to yield an ionomer weight fraction (including Ir, perylene red, ionomer) of 10.6%, which translates to an ionomer solids volume fraction of 51% (comparing ionomer, perylene red and iridium content). The formulation details of Example A are summarized in Table 3.

TABLE 3

| | Electrode Ink | | | | | Dry Electrode |
|---|---|---|---|---|---|---|
| | Ionomer | Electrode Ink | Electrode Ink | Dry Electrode | Dry Electrode | Acicular |
| | Solids Added | Catalyst Added | Solvent Added | Ionomer | Ionomer | Particle |
| Example | (g) | (g) | (g) | wt % | vol % | vol % |
| A | 0.236 | 2.0 | 65.2 | 10.6 | 51.2 | 48.8 |
| B | 0.205 | 2.0 | 65.2 | 9.3 | 50.9 | 49.1 |
| C | 0.124 | 2.2 | 65.2 | 5.3 | 62.2 | 37.8 |

### Example B

Example B was formulated similarly to Example A, except that the Ir-coated PR 149 whiskers from Preparatory Example E were used and the electrode ink composition yielded an ionomer weight fraction (including Ir, perylene red, ionomer) of 9.3%, which translates to an ionomer solids volume fraction of 51% (comparing ionomer, perylene red and iridium content, summarized in Table 3.

### Example C

Example C was formulated similarly to Example A, except that the Ir-coated PR 149 whiskers from Preparatory Example F were used and the electrode ink composition yielded an ionomer weight fraction (including Ir, perylene red, ionomer) of 5.3%, which translates to an ionomer solids volume fraction of 62% (comparing ionomer, perylene red and iridium content), summarized in Table 3.

Preparation of Catalyst-coated-membrane (CCM) for Comparative Examples A-C

A catalyst-coated-membrane (CCM) was made by transferring the catalyst coated whiskers described above onto both surfaces (full CCM) of a 100 μm thick 3M825EW MEMBRANE using the processes as described in detail in U.S. Pat. No. 5,879,827 (Debe et al.). The Cathode Preparation from above (a 0.25 mg/cm² Pt-NSTF catalyst layer) was laminated to one side (intended to become the cathode side) of the PEM, and an Ir-NSTF (one of Preparatory Examples A-C) was laminated to the other (anode) side of the membrane. The catalyst transfer was accomplished by hot roll lamination of the catalysts (on their respective substrates) onto the membrane using a laminator (obtained under the trade designation “HL-101” from ChemInstruments, Inc., West Chester Township, Ohio, USA). The hot roll temperatures were 350° F. (177° C.) and the gas line pressure was fed to force laminator rolls together at the nip at 150 psi (1.03 MPa). The Pt-catalyst and Ir-catalyst coated MCTSs were precut into 15.2 cm×11.4 cm rectangular shape and sandwiched onto two side of a 10.8 cm×10.8 cm portion of 3M825EW PEM. The membrane with catalyst coated MCTS on both sides was placed between 2 mil (51 micrometer) thick polyimide films and then paper was placed on the outsides, prior to passing the stacked assembly through the nip of the hot roll laminator at a speed of 1.2 ft./min. (37 cm/min.). Immediately after passing through the nip, while the assembly was still warm, the layers of polyimide and paper were quickly removed and the Cr-coated MCTS substrate and the PET substrate were peeled off the CCM by hand, leaving the catalyst coated whiskers stuck to the PEM surfaces. The catalyst coated whiskers stuck to the PEM surfaces form an electrode, consisting of a single layer of oriented whiskers partially embedded into the surface. The areal Ir loading of the anode electrode is listed in Table 4.

TABLE 4

| | | Electrode Ir Areal |
|---|---|---|
| Example | Anode | Loading (mg/cm²) |
| Comparative Example A | Preparatory Example A | 0.750 |
| Comparative Example B | Preparatory Example B | 0.500 |
| Comparative Example C | Preparatory Example C | 0.200 |
| Example 1 | Example A | 0.215 |
| Example 2 | Example A | 0.655 |
| Example 3 | Example A | 0.669 |
| Example 4 | Example B | 0.143 |
| Example 5 | Example B | 0.264 |
| Example 6 | Example B | 0.737 |
| Example 7 | Example B | 0.739 |
| Example 8 | Example C | 0.798 |

### Example 1

The electrode ink from Example A was coated onto a transfer substrate using a Mayer Rod controlled by an automated Mayer rod coater (obtained under the trade designation “GARDCO AUTOMATIC DRAWDOWN MACHINE”, obtained from Paul N. Garner Co., Pompano Beach, Fla., USA). After coating, the coated substrate was dried in an inerted (nitrogen flowing) oven to at least remove effectively most, if not all, solvent from the electrode composition, leaving a dry electrode layer on the substrate. After drying, the mass of the dry electrode coating and liner were measured, and the known liner mass was subtracted. The areal mass loading of the dry electrode was obtained by dividing the dry electrode mass by the area of the substrate. Using the dry electrode composition information from Table 3, above, and the catalyst composition information from Table 2, the electrode Ir areal loading was calculated to be 0.215 mg/cm², listed in Table 4.

The catalyst-coated membrane (CCM) was made by laminating the Cathode Preparation from above (a 0.25 mg/cm² Pt-NSTF catalyst layer) to one side (intended to become the cathode side) of the PEM (a 100 μm thick 3M825EW membrane) using the processes as described in detail in U.S. Pat. No. 5,879,827 (Debe et al.). The dispersed Ir-NSTF catalyst layer on transfer substrate was laminated to the other (anode) side of the membrane. The catalyst transfer was accomplished by hot roll lamination of the catalysts (on their respective substrates) onto the membrane using a laminator (obtained under the trade designation “HL-101” from ChemInstruments, Inc., West Chester Township, Ohio, USA). The hot roll temperatures were 350° F. (177° C.) and the gas line pressure was fed to force laminator rolls together at the nip at 150 psi (1.03 MPa). The Pt-catalyst coated MCTS was precut into 15.2 cm×11.4 cm rectangular shape and sandwiched onto one side of a 10.8 cm×10.8 cm portion of PEM. The Example A on liner was precut into 7.5 cm×7.5 cm square shape and sandwiched onto the other side of the 10.8 cm×10.8 cm portion of PEM. The membrane, with the Example A electrode on liner on one side and the cathode catalyst-coated MCTS on the other side, was placed between 2 mil (51 micrometer) thick polyimide films and then paper was placed on the outside, prior to passing the stacked assembly through the nip of the hot roll laminator at a speed of 1.2 ft./min. (37 cm/min.). Immediately after passing through the nip, while the assembly was still warm, the MCTS substrates and liner layers of polyimide and paper were quickly removed, following by peel-removal of the MCTS substrate and Example A substrate, leaving the electrodes stuck to the PEM surfaces.

### Examples 2 and 3

The catalyst-coated membrane for Examples 2 and 3 were prepared similarly to Example 1, except that the coating process for the electrode ink from Example A was varied to yield Ir areal loadings of 0.655 and 0.669 mg/cm² in the dried electrode coatings, respectively, listed in Table 4.

### Examples 4, 5, 6, and 7

The catalyst-coated membrane for Examples 4, 5, 6, and 7 were prepared similarly to Example 1, except that the electrode ink from Example B was used instead of Example A, and the electrode coatings were varied to yield Ir areal loadings for Examples 4, 5, 6, and 7 of 0.143, 0.264, 0.737, and 0.739 mg/cm², respectively, listed in Table 4.

### Example 8

The catalyst-coated membrane for Examples 8 was prepared similarly to Example 1, except that the electrode ink from Example C was used instead of Example A to form the electrodes, and the electrode was coated to result in an Ir areal loading was 0.798 mg/cm², listed in Table 4.

Test Cell

The full CCMs fabricated in the above Examples and Comparative Examples were tested in a water electrolyzer single cell. The full CCM was installed with appropriate gas diffusion layers directly into a 50 cm² single cell test station (obtained under the trade designation “50SCH” from Fuel Cell Technologies, Albuquerque, N. Mex.,) with quad serpentine flow fields. The normal graphite flow field block on the anode side was replaced with a Pt-plated Ti flow field block of the same dimensions and flow field design (obtained from Giner, Inc., Auburndale, Mass.,) in order to withstand the high anode potentials during electrolyzer operation.

The membrane electrode assemblies were formed as follows: 1) a nominally incompressible cathode gasket made from a glass-reinforced polytetrafluoroethylene (PTFE) film (obtained under the trade designation “PTFE COATED FIBERGLASS”, obtained from Nott Company, Arden Hills, Minn., USA), the selected film having a thickness calculated to provide the desired gas diffusion layer compression in the assembled cell; the prepared gasket, having 10 cm×10 cm outside size and 7 cm×7 cm inside hollow, was put on the surface of the graphite flow field block of a 50 cm² Fuel Cell Technologies (Albuquerque, N. Mex.) electrochemical cell (model SCH50, as noted above); 2) a selected cathode porous carbon paper was put in the hollow part of the gasket, with the hydrophobic surface (when present) facing up to contact with the cathode catalyst side of the CCM; 3) the prepared CCM was put on the surface of the carbon paper, with the cathode side with H2 evolution reaction (HER) catalyst placed in contact with the (hydrophobic) surface of the carbon paper; 4) an anode gasket with 10 cm×10 cm outside size and 7 cm×7 cm inside hollow was placed on the oxygen evolution catalyst-coated surface of the CCM; 5) the anode gas diffusion layer (a nonwoven titanium sheet available under the trade designation “BEKIPOR TITANIUM” from Bekaert Corp, Marietta, Ga., coated with 0.5 mg/cm² of platinum) was placed in the hollow part of the anode gasket with the platinum-plated side facing the anode catalyst (Ir) side of the CCM; 6) the platinized titanium flow field block was placed on the surface of the anode gas diffusion layer and gasket. Then the titanium flow field block, anode gas diffusion layer, CCM, cathode gas diffusion layer, and the graphite flow field block were compressed together with screws. The parts were checked to ensure they could be uniformly assembled and sealed.

Purified water with a resistivity of 18 Mohm-cm was supplied to the anode at 75 mL/min. A power supply (obtained under the trade designation “ESS”, model ESS 12.5-800-2-D-LB-RSTL from TDK-Lambda, Neptune, N.J.) was connected to the cell and was used to control the applied cell voltage or current density. The cell voltage was measured using a voltmeter (obtained under the trade designation “FLUKE”, Model 8845A 6½ DIGIT PRECISION MULTIMETER, from FLUKE Corporation). The cell current was measured by the power supply.

Cell performance was assessed by measurement of a polarization curve, where the cell current density was measured over a range of cell voltages at the temperature at 80° C. and water flow rate of 75 mL/min to the cell anode. Using the power supply, the cell voltage was set to 1.40 V and held for 300 s. During the 300 s hold, the current density and cell voltage were measured at approximately one point per second. This measurement process was repeated at 1.45, 1.50, 1.55, 1.60, 1.65, 1.70, 1.75, 1.80, 1.85, 1.90, 1.95, and 2.00 V, completing the first half of the polarization curve. The second half of the polarization curve consisted of analogous current and voltage measurements at setpoints of 2.00 V, 1.95, 1.90, 1.85, 1.80, 1.75, 1.70, 1.65, 1.60, 1.55, 1.50, 1.45, and 1.40 V.

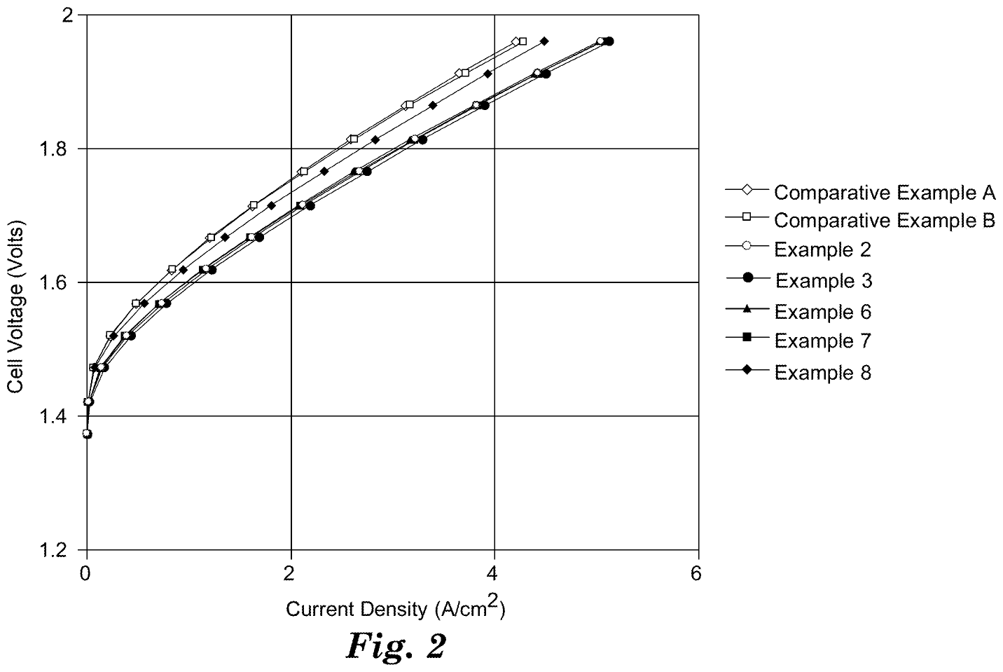

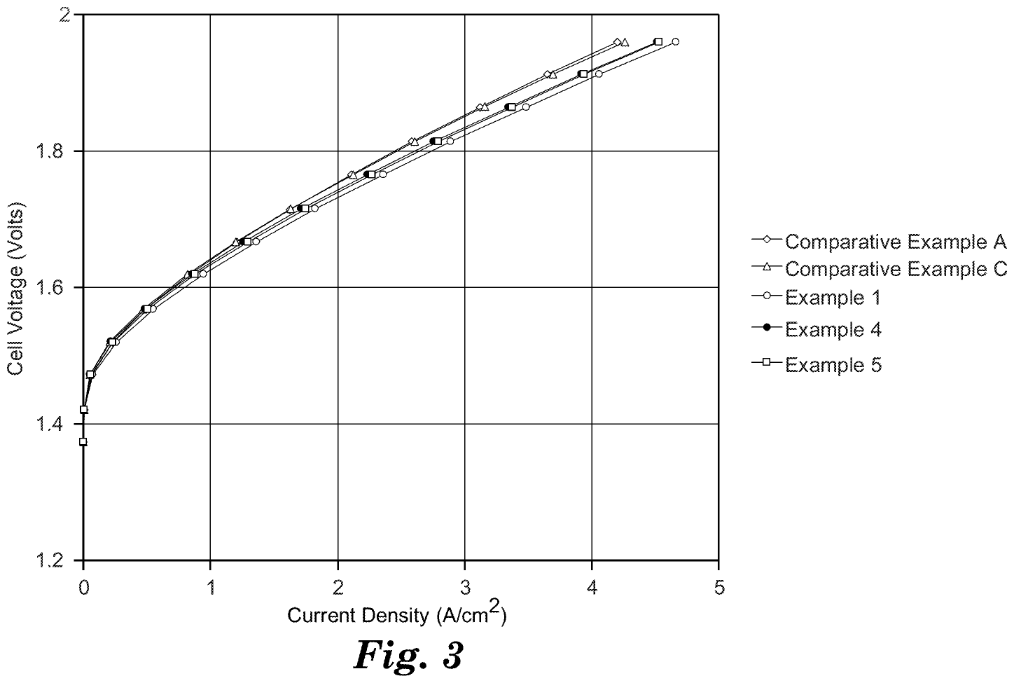

The final polarization curve data was analyzed as follows. First, the measured current densities and cell voltages vs. time from the first half of the polarization curve (the portion increasing from 1.40 V to 2.00 V) were independently averaged over the 300 s at each setpoint, producing an averaged polarization curve. FIGS. 2 and 3 are plots containing the averaged polarization curves of the Comparative Examples and the Examples. Next, the current densities at specific cell voltages of 1.45, 1.50, and 1.55 V were obtained by linearly interpolating the averaged polarization curve data. The interpolated current densities are listed in Table 5, below. FIG. 4 is a plot of the interpolated current density at 1.50 V as a function of anode electrode Ir areal loading of the Comparative Examples and Examples.

TABLE 5

| | Current | Current | Current |
|---|---|---|---|
| | Density @ | Density @ | Density @ |
| | 1.45 V | 1.50 V | 1.55 V |
| Example | (A/cm²) | (A/cm²) | (A/cm²) |
| Comparative Example A | 0.039 | 0.161 | 0.389 |
| Comparative Example B | 0.037 | 0.157 | 0.387 |
| Comparative Example C | 0.032 | 0.144 | 0.369 |
| Example 1 | 0.045 | 0.184 | 0.443 |
| Example 2 | 0.091 | 0.290 | 0.607 |
| Example 3 | 0.107 | 0.320 | 0.648 |
| Example 4 | 0.031 | 0.145 | 0.379 |
| Example 5 | 0.037 | 0.159 | 0.401 |
| Example 6 | 0.080 | 0.268 | 0.575 |
| Example 7 | 0.082 | 0.270 | 0.580 |
| Example 8 | 0.043 | 0.182 | 0.445 |

Results

FIG. 4 and Table 5 compare the current density at 1.50 V of Comparative Examples A, B, and C and Examples 1, 2, 3, 4, 5, 6, 7, and 8 as a function of anode electrode Ir areal loading. At 1.50 V cell voltage, the measured current density is an approximate proportional measure of the absolute catalytic activity of the anode electrode. Higher current densities at a given cell voltage indicated higher absolute catalyst activity. The anode electrodes of Comparative Examples A, B, and C consisted of a single oriented layer of Ir-coated whiskers embedded into the surface of the membrane, with approximately the same areal number density of whiskers per unit area on the membrane as on the MCTS growth substrate, approximately 68 per square micrometer. The variation in Ir content in these electrodes was implemented by varying the amount of Ir deposited onto the whiskers, which increased the thickness of the Ir metal thin film on the support whisker. As discussed above, the specific surface area (surface area per unit mass) may decrease as the Ir thin film thickness is increased. For Comparative Examples A and C, the current density increased from 0.032 to 0.039 A/cm², approximately 23%, as the electrode loading increased from 0.20 to 0.75 mg/cm², approximately 275%, coincident with an increase in the Ir metal thickness on support from 8.9 to 33.2 nm.

The anode electrodes of Examples 1-8 consist of multiple Ir-coated whiskers randomly distributed within an ionomer-containing electrode. The areal number density of Ir-coated whiskers per unit electrode area can be tailored based on the choice of electrode ink fabrication parameters (e.g., whisker-to-ionomer weight ratio, solvent ratio at a given wet coating thickness) and the dried electrode coating thickness. Variation in the areal Ir loading per unit electrode area was accomplished by selecting the electrode coating thickness and the Ir coating thickness on the PR 149 whisker supports. Depending upon the choice of fabrication parameters, the areal number density of whiskers per unit electrode area may range above and below the areal number density of the Ir-coated PR 149 whiskers on the MCTS growth substrate, approximately 68 per square micrometer.

For Examples 1 and 3, comprising PR 149 whiskers with a 2.2 nm thick Ir coating, the current density increased from 0.045 to 0.107 A/cm², 134%, as the electrode Ir areal loading increased from 0.215 to 0.669 mg/cm². For Examples 4 and 7, comprising PR 149 whiskers with a 4.4 nm thick Ir coating, the current density increased from 0.031 to 0.082 A/cm², 161%, as the electrode Ir areal loading increased from 0.143 to 0.739 mg/cm².

Examples 2, 3, 6, 7, and 8 have Ir areal electrode loadings ranging from 0.655 to 0.798 mg/cm² and comprise PR 149 whiskers with 2.2, 4.4, and 16.6 nm thick Ir coatings. Within this loading range, the current density at 1.50 V increased monotonically from 0.043 to 0.080-0.082 to 0.091-0.107 A/cm² as the Ir thickness on the PR 149 support decreased from 16.6 to 4.4 to 2.2 nm.

Over similar ranges of Ir areal electrode loadings, the increase in absolute current density of Example 3 over Example 1, 134%, was higher than the increase in absolute current density of Comparative Example C vs. Comparative Example A, 23%.

Typically, as electrode thickness increases, electrode resistance also increases and at higher current densities, the improvements observed at low current densities are outweighed due to resistive losses that become greater than the low current density improvements. In the present examples, it was unexpectedly found that the improvement in performance of the Examples over the Comparative Examples observed at relatively lower current densities and lower cell voltages (e.g. near 1.50V) were also maintained at higher current densities and higher cell voltages (e.g. near 1.90V).

Foreseeable modifications and alterations of this invention will be apparent to those skilled in the art without departing from the scope and spirit of this invention. This invention should not be restricted to the embodiments that are set forth in this application for illustrative purposes. Documents disclosed herein are incorporated by reference in their entirety. To the extent that there is any conflict or discrepancy between this specification as written and the disclosure in any document mentioned or incorporated by reference herein, this specification as written will prevail.

1. An electrode composition for an electrolyzer, the electrode composition comprising:
(a) an ionomer binder; and
(b) less than 54 solids volume % of a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum.

2. The electrode composition of claim 1, wherein the catalytic material further comprises at least one of ruthenium or ruthenium oxide.

3. The electrode composition of claim 1, wherein the iridium comprises iridium oxide.

4. The electrode composition of claim 1, wherein the layer of catalytic material comprises a nanostructured catalyst layer.

5. The electrode composition of claim 1, wherein the polynuclear aromatic hydrocarbon comprises perylene red.

6. The electrode composition of claim 1, wherein the acicular particles have an aspect ratio of at least 3.

7. The electrode composition of claim 1, wherein the ionomer binder comprises at least one of perfluorosulfonic acid, perfluorosulfonimide-acid, sulfonated polyimides, perfluoroimides, sulfonated polytrifluorostyrene, sulfonated hydrocarbon polymer, polysulfone, polyethersulfone, and combinations thereof.

8. The electrode composition of claim 1, wherein the ionomer binder has an equivalent weight of not greater than 1100.

9. The electrode composition of claim 1, wherein the layer of catalytic material on the at least one portion of the surface of the microstructured core has a thickness of less than 100 nm.

10. A catalyst ink composition for an electrolyzer, the composition comprising:
(a) an ionomer binder;
(b) less than 54 solids volume % of a plurality of acicular particles, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof; wherein the catalytic material comprises iridium; and wherein the acicular particles are substantially free of platinum; and
(c) solvent;
wherein the plurality of acicular particles is dispersed throughout the electrode composition.

11. (canceled)

12. (canceled)

13. An electrolyzer comprising:
a proton-exchange membrane having first and second opposed major surfaces;
a cathode on the first major surface of the proton-exchange membrane;
an anode on the second major surface of the proton-exchange membrane, wherein the anode comprises (a) an ionomer binder; and (b) a plurality of acicular particles, wherein the plurality of acicular particles is dispersed throughout the electrode composition, and wherein the acicular particles comprise a microstructured core with a layer of catalytic material on at least one portion of the surface of the microstructured core, wherein the microstructured core comprises at least one of a polynuclear aromatic hydrocarbon, heterocyclic compounds, and combinations thereof, and the catalytic material comprises iridium and wherein the acicular particles are substantially free of platinum;
a first gas diffusion layer contacting the cathode;
a second gas diffusion layer contacting the anode; and
an electrical power source connected to the cathode and the anode.

14. (canceled)

15. (canceled)

16. The electrode composition of claim 1, wherein the layer of catalytic material on the at least one portion of the surface of the microstructured core has a thickness of less than 100 nm.

17. The electrode composition of claim 1, wherein the layer of catalytic material on the at least one portion of the surface of the microstructured core has a thickness of at least 0.5 nm and at most 10 nm.

18. The catalyst ink of claim 10, wherein the solvent comprises at least one of an alcohol, a polyalcohol, a ketone, water, a fluorinated solvent, and combinations thereof.

19. The catalyst ink of claim 10, wherein the composition comprises 1-40 wt % solids.

20. The electrolyzer of claim 13, wherein the composition comprises less than 54 solids volume % of the plurality of acicular particles.

21. The electrolyzer according to claim 13, wherein the layer of catalytic material comprises a nanostructured catalyst layer.

22. The electrolyzer according to claim 13, wherein the layer of catalytic material on the at least one portion of the surface of the microstructured core has a thickness of less than 100 nm.

23. The electrolyzer according to claim 13, wherein the layer of catalytic material on the at least one portion of the surface of the microstructured core has a thickness of at least 0.5 nm and at most 10 nm.
